(19) United States
(12) Patent Application Publication
(10) Pub. No.: US 2025/0379307 A1
(43) Pub. Date: Dec. 11, 2025

(54) BATTERY CASE AND BICYCLE PEDAL MODULE USING THE SAME

(71) Applicant: WELLGO PEDAL'S CORP., TAICHUNG CITY (TW)

(72) Inventor: CHUN-RONG CHEN, TAICHUNG CITY (TW)

(21) Appl. No.: 18/734,159

(22) Filed: Jun. 5, 2024

(51) Int. Cl. H01M 50/213; B62M 3/08; H01M 50/249; H01M 50/264; H01M 50/526; H01M 50/557

(52) U.S. Cl. CPC H01M 50/213; B62M 3/08; H01M 50/249; H01M 50/264; H01M 50/526; H01M 50/557; H01M 2220/20

(57) ABSTRACT

A battery case and a bicycle pedal module using the same are provided, and the battery case includes a first housing and a second housing. The first housing includes a first conductive holder and a first insulating layer. The first conductive holder is partially covered with the first insulating layer, and a portion of the first conductive holder exposed outside the first insulating layer forms a first contact portion. The second housing includes a second conductive holder and a second insulating layer. The second conductive holder is partially covered with the second insulating layer, and a portion of the second conductive holder exposed outside the second insulating layer forms a second contact portion. The first housing and the second housing are connected with each other to receive a battery, and the first contact portion and the second contact portion are electrically connected with the battery.

### BACKGROUND OF THE INVENTION

### Field of the Invention

The present invention relates to a battery case and a bicycle pedal module using the same.

### Description of the Prior Art

An electronic device is usually powered by wired connections. For example, a metal piece of a battery case is connected with a circuit board by a wire, and the advantage of using wires is that they are flexible and bendable to meet different requirements.

However, the wires are easy to be damaged or be detached from welding points due to unexpected external forces. Therefore, when the electronic device is used in an environment that is prone to shaking (such as when used on a bicycle) or when components or batteries of the electronic device are replaced, the wires and their welding points are easy to fall off or be broken. In addition, for hiding the wires in the electronic device, the assembling process of the electronic device is time consuming, and a volume of the electronic device is increased, which results in a poor appearance.

The present invention is, therefore, arisen to obviate or at least mitigate the above-mentioned disadvantages.

### SUMMARY OF THE INVENTION

The main object of the present invention is to provide a battery case and a bicycle pedal module using the same, which has a simple structure, small volume and provides stable conductivity.

To achieve the above and other objects, the present invention provides a battery case, including: a first housing and a second housing. The first housing includes a first conductive holder and a first insulating layer, the first conductive holder is partially covered with the first insulating layer, and a portion of the first conductive holder exposed outside the first insulating layer forms a first contact portion and a first output portion. The second housing includes a second conductive holder and a second insulating layer, the second conductive holder is partially covered with the second insulating layer, and a portion of the second conductive holder exposed outside the second insulating layer forms a second contact portion and a second output portion. The first housing and the second housing are connected with each other to receive a battery therebetween, and the first contact portion and the second contact portion are configured to be electrically connected with the battery. The first output portion and the second output portion are configured to be electrically connected with an electronic module.

To achieve the above and other objects, the present invention further provides a bicycle pedal module using the battery case as described above, and the bicycle pedal module includes: a pedal body, a shaft assembly, a conductive module and the battery case as described above. One side of the shaft assembly is disposed within the pedal body, and the other side of the shaft assembly is configured to be connected with a crank. The conductive module is positioned on a side of the shaft assembly remote from the pedal body and includes a positive contact unit, a negative contact unit, a positive output end and a negative output end. The positive contact unit is electrically connected with the positive output end, and the negative contact unit is electrically connected with the negative output end. The positive output end and the negative output end are configured to be electrically connected with an electronic module. The battery case is detachably disposed on the conductive module. The first output portion and the negative contact unit are abutted against and electrically conducted with each other, and the second output portion and the positive contact unit are abutted against and electrically conducted with each other.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of FIG. 1;

FIG. 3 is a breakdown drawing according to FIG. 2 as viewed in another side;

FIG. 4 is a stereogram showing assembling of a PCB conductor, positive pins and negative pins according to a preferable embodiment of the present invention;

FIG. 5 is a stereogram showing a conductive module according to a preferable embodiment of the present invention;

FIG. 6 is a cross-sectional view of FIG. 1;

FIG. 7 is a drawing showing a position of a battery case according to a preferable embodiment of the present invention during pedaling; and

FIG. 8 is a drawing showing rotational adjustment of the battery case according to a preferable embodiment of the present invention.

### DETAILED DESCRIPTION OF THE PREFERRED EMBODIMENTS

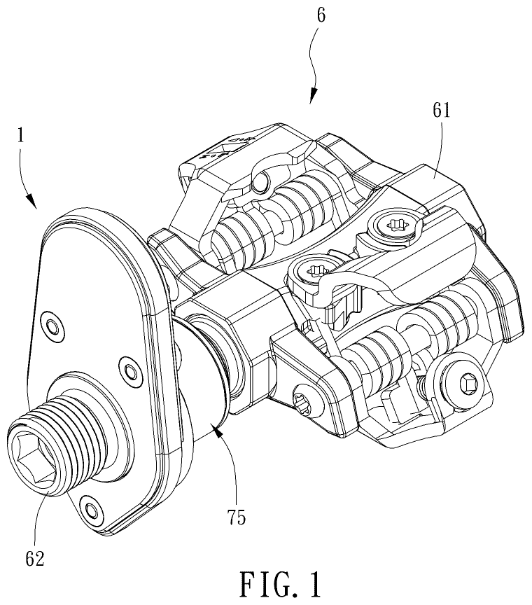

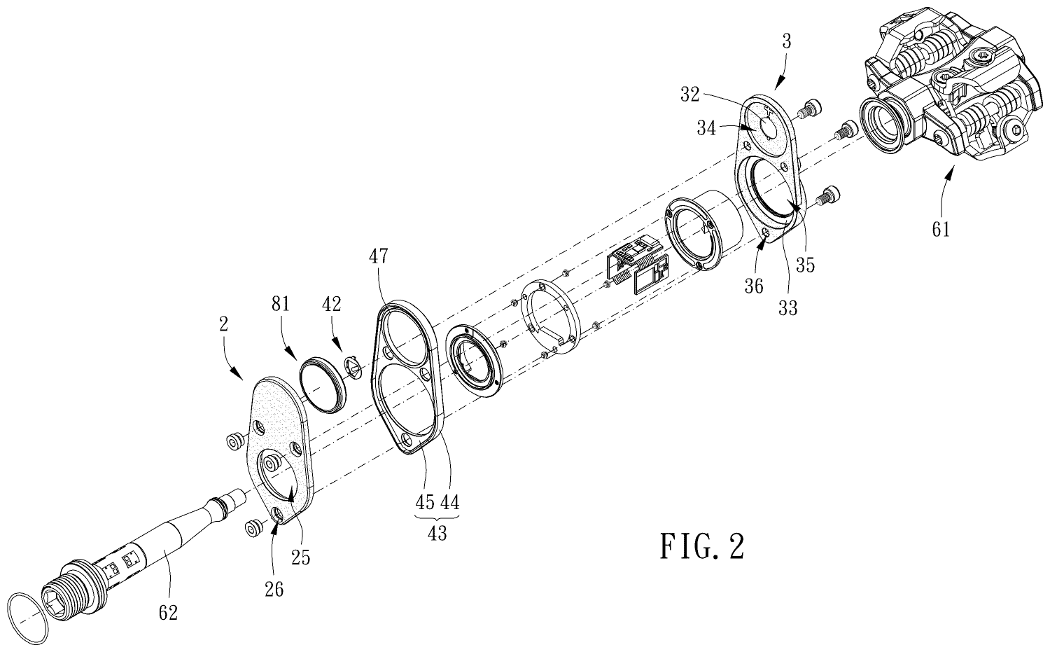

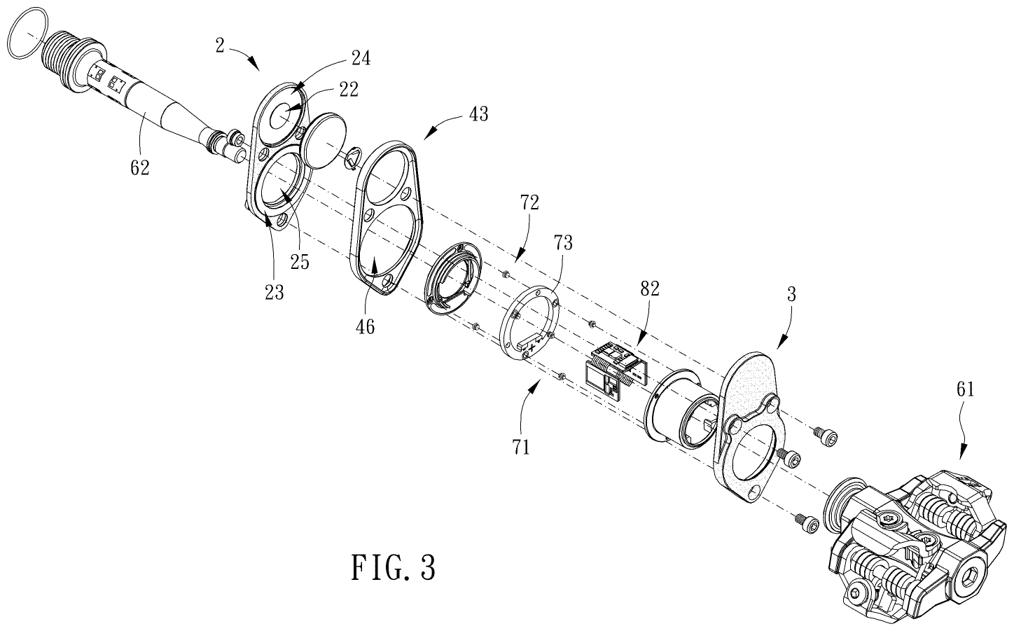

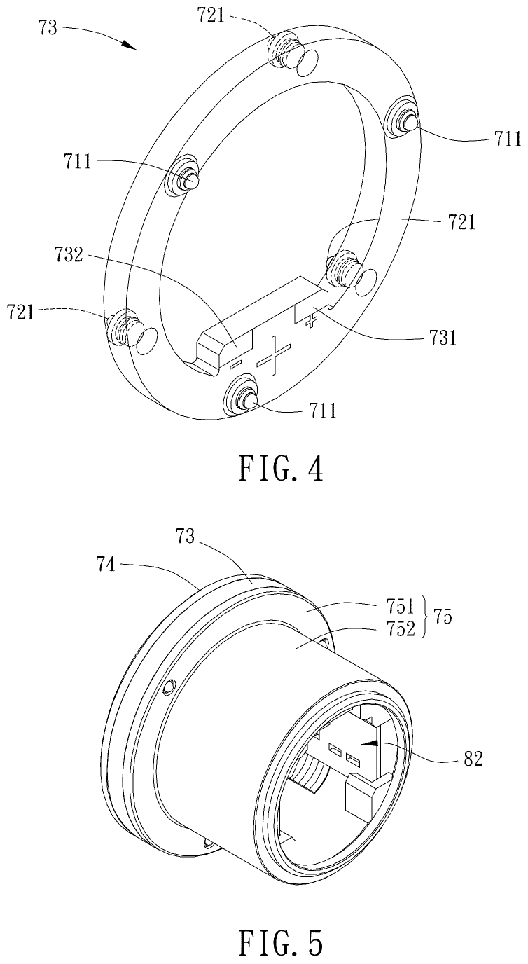

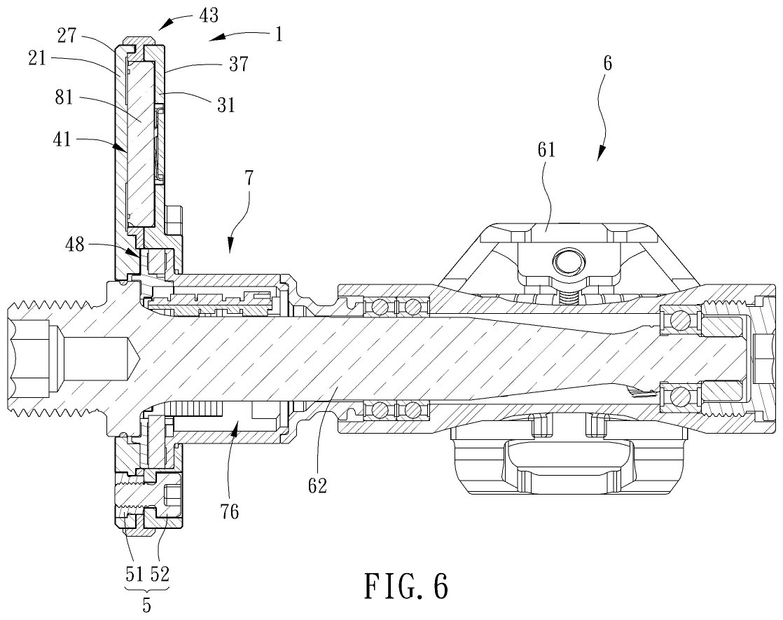

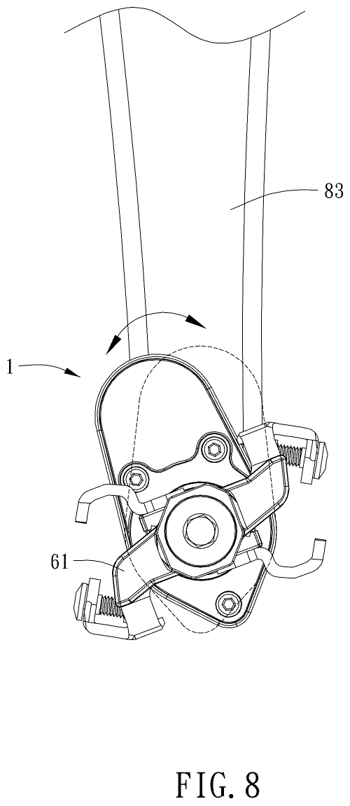

Please refer to FIGS. 1 to 8 for a preferable embodiment of the present invention. A battery case 1 of the present invention is configured to be arranged outboard at a bicycle pedal module 6, and the battery case 1 includes: a first housing 2 and a second housing 3.

The first housing 2 includes a first conductive holder 21 and a first insulating layer 27. The first conductive holder 21 is partially covered with the first insulating layer 27, and a portion of the first conductive holder 21 exposed outside the first insulating layer 27 forms a first contact portion 22 and a first output portion 23. Similarly, the second housing 3 includes a second conductive holder 31 and a second insulating layer 37. The second conductive holder 31 is partially covered with the second insulating layer 37, and a portion of the second conductive holder 31 exposed outside the second insulating layer 37 forms a second contact portion 32 and a second output portion 33. The first housing 2 and the second housing 3 are connected with each other to receive a battery 81 therebetween, and the first contact portion 22 and the second contact portion 32 are configured to be electrically connected with the battery 81. The first output portion 23 and the second output portion 33 are configured to be electrically connected with an electronic module 82 (such as a cadence sensing module).

Therefore, an electric power of the battery 81 is wirelessly transmitted to the electronic module 82 by the first conductive holder 21 and the second conductive holder 31, which greatly simplifies and minimizes a structure of the battery case 1. In addition, the welding process for connecting wires in prior arts is unnecessary so that the battery case 1 can be processed quickly, and there are no wires and welding points. The battery case 1 of the present invention is suitable to use in an dynamic environment, such as the bicycle pedal module 6. Moreover, when a user replaces the battery 81 which is disposable, it can be assembled quickly without worrying about damaging the conductive structures (such as wires and welding points).

Specifically, the first conductive holder 21 is made of aluminum alloy, and the second conductive holder 31 is also made of aluminum alloy, which is easy to process and provides good structural strength, good conductivity, preferable appearance and light weight. In a manufacturing process of the first housing 2, the first conductive holder 21 is subjected to an insulation process and the first conductive holder 21 is completely covered with the first insulating layer 27. Then, portions of the first insulating layer 27 are cut off to form the first contact portion 22 and the first output portion 23. A manufacturing process of the second housing 3 is the same as the manufacturing process of the first housing 2.

The first conductive holder 21 further includes a first recess 24, and the first contact portion 22 is disposed on a wall defining the first recess 24. The second conductive holder 31 further includes a second recess 34, and the second contact portion 32 is disposed on a wall defining the second recess 34. The first recess 24 and the second recess 34 are communicated with each other and form a battery receiving room 41 therebetween, and the battery receiving room 41 is configured to receive the battery 81. Preferably, the battery 81 is a button battery, which is facilitate to miniaturization and provides advantages of long service life, low self-discharge rate and stable output voltage.

The battery case 1 further includes a conductive elastomer 42, and the conductive elastomer 42 is received within the second recess 34. One side of the conductive elastomer 42 is abutted against the second contact portion 32, and another side of the conductive elastomer 42 is configured to be abutted against the battery 81. The conductive elastomer 42 can eliminate the dimensional error of the battery 81 and ensure the conduction between the second contact portion 32 and the battery 81. The conductive elastomer 42 may be disposed within the first recess 24.

The first conductive holder 21 has a first through hole 25 disposed therethrough, and the second conductive holder 31 has a second through hole 35 disposed therethrough. The first through hole 25 and the second through hole 35 are coaxially arranged and configured for a shaft assembly 62 of the bicycle pedal module 6 to be disposed therethrough so that the battery case 1 can be disposed outboard at the shaft assembly 62.

The first housing 2 and the second housing 3 define an accommodating room 48 therebetween, and the accommodating room 48 is configured to receive a conductive module 7 electrically connected with the electronic module 82. The first output portion 23 and the second output portion 33 are respectively disposed on sidewalls of the first housing 2 and the second housing 3 defining the accommodating room 48. The first through hole 25 and the second through hole 35 respectively penetrate through the sidewalls. In this embodiment, the first output portion 23 and the second output portion 33 are respectively annularly disposed around an outside of the first through hole 25 and an outside of the second through hole 35.

Preferably, the battery case 1 further includes a sealing member 43. The first housing 2 is plate-shaped, the second housing 3 is plate-shaped, and the first housing 2 and the second housing 3 restricts the sealing member 43 therebetween so that the sealing member 43 can effectively block external moisture to ensure that no short circuit occurs. Specifically, the sealing member 43 includes a frame portion 44 and a plate portion 45, and the plate portion 45 laterally extends within the frame portion 44. The plate portion 45 has a third through hole 46 disposed therethrough, and the third through hole 46 and the first through hole 25 are coaxially arranged. A portion of the first housing 2 and a portion of the second housing 3 are disposed within the frame portion 44 and restrict the plate portion 45 therebetween to block external moisture. The plate portion 45 further has an annular projection 47 disposed thereon, and the annular projection 47 is abutted against and between the first housing 2 and the second housing 3 and configured to be disposed around the battery 81. The annular projection 47 can also prevent external moisture from entering the battery receiving room 41 and provide a good usage environment for the battery 81.

The battery case 1 further includes at least one fastening assembly 5. The first conductive holder 21 further includes at least one first assembling hole 26, and the second conductive holder 31 further includes at least one second assembling hole 36. A position of the at least one second assembling hole 36 is matched with a position of the at least one first assembling hole 26, and the at least one fastening assembly 5 is disposed through the at least one first assembling hole 26 and the at least one second assembling hole 36 to connect the first housing 2 with the second housing 3. The first insulating layer 27 covers a wall defining the at least one first assembling hole 26, and the second insulating layer 37 covers a wall defining the at least one second assembling hole 36 so as to avoid conduction between the battery 81 and the at least one fastening assembly 5.

In this embodiment, the at least one fastening assembly 5 includes a nut 51 and a bolt 52, the nut 51 is embedded within the at least one first assembling hole 26, and the bolt 52 is disposed through the second assembling hole 36 and screwed to the nut 51. A clamping degree of the first housing 2 and the second housing 3 is adjustable by tuning the bolt 52.

The present invention further provides a bicycle pedal module, including: a pedal body 61, the shaft assembly 62, the conductive module 7 and the battery case 1 as described above.

One side of the shaft assembly 62 is disposed within the pedal body 61, and the other side of the shaft assembly 62 is configured to be connected with a crank 83. The conductive module 7 is positioned on a side of the shaft assembly 62 remote from the pedal body 61, and the conductive module 7 includes a positive contact unit 71, a negative contact unit 72, a positive output end 731 and a negative output end 732. The positive contact unit 71 is electrically connected with the positive output end 731, and the negative contact unit 72 is electrically connected with the negative output end 732. The positive output end 731 and the negative output end 732 are configured to be electrically connected with an the electronic module 82. The battery case 1 is detachably disposed on the conductive module 7. The first output portion 23 and the negative contact unit 72 are abutted against and electrically conducted with each other, and the second output portion 33 and the positive contact unit 71 are abutted against and electrically conducted with each other.

The conductive module 7 further includes a printed circuit board (PCB) conductor 73, a pressing member 74 and a sleeve member 75. The PCB conductor 73 has the positive output end 731 and the negative output end 732 disposed thereon, and the sleeve member 75 includes a supporting portion 751 and a tube portion 752. The supporting portion 751 laterally protrudes from the tube portion 752, and the PCB conductor 73 is abutted against and between the pressing member 74 and the supporting portion 751. The first housing 2 and the second housing 3 are assembled from an outer side of the pressing member 74 and an outer side of the supporting portion 751 respectively. The positive contact unit 71 includes a plurality of positive pins 711, and the negative contact unit 72 includes a plurality of negative pins 721. The plurality of positive pins 711 and the plurality of negative pins 721 are connected with the PCB conductor 73 and electrically conducted with the positive output end 731 and the negative output end 732. One end of each of the plurality of positive pins 711 is disposed through one of the pressing member 74 and the supporting portion 751 and abutted against the second output portion 33, and one end of each of the plurality of negative pins 721 is disposed through the other of the pressing member 74 and the supporting portion 751 and abutted against the first output portion 23. The sleeve member 75 is sleeved to the shaft assembly 62, and the tube portion 752 and the shaft assembly 62 define a chamber 76 therebetween. The chamber 76 is configured to receive the electronic module 82, and the positive output end 731 and the negative output end 732 protrude into the chamber 76.

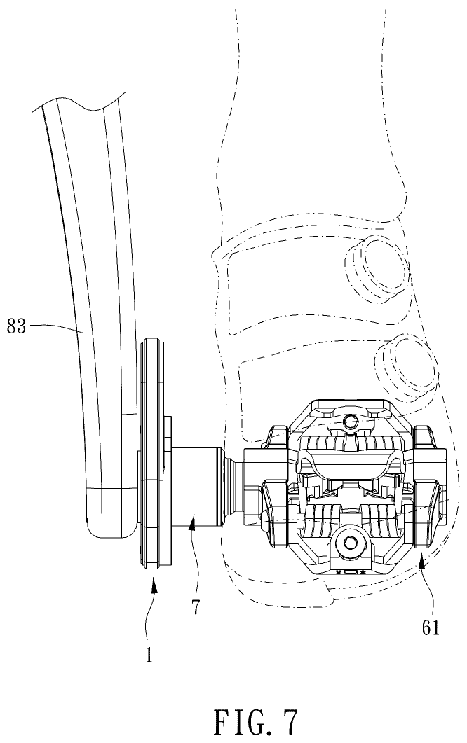

In operation, the battery case 1 is located between the crank 83 and the pedal body 61, and the battery case 1 is relatively close to the crank 83. The battery case 1 is thin and light, which provides sufficient space for pedaling and avoids interference and collision with the user's feet, as shown in FIG. 7.

Preferably, the battery case 1 is rotatably disposed on the conductive module 7. When the shaft assembly 62 is assembled to the crank 83, the battery case 1 is rotated to be aligned with the crank 83 as viewed in an axial direction of the shaft assembly 62, and the battery case 1 does not protrude beyond the crank 83 in a radial direction of the shaft assembly 62, as viewed in figured 8, which effectively avoids lateral collisions when the battery case 1 is rotated with the crank 83. In this embodiment, a clamping force that the first housing 2 and the second housing 3 exerted on the conductive module 7 is adjusted by rotating the at least one fastening assembly 5. When the at least one fastening assembly 5 is loosened, the battery case 1 is rotatable relative to the conductive module 7; on the contrary, when the at least one fastening assembly 5 is fastened, the battery case 1 tightly restricts the conductive module 7.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A battery case, configured to be arranged outboard at a bicycle pedal module, the battery case including:
a first housing, including a first conductive holder and a first insulating layer, the first conductive holder partially covered with the first insulating layer, a portion of the first conductive holder exposed outside the first insulating layer forming a first contact portion and a first output portion; and
a second housing, including a second conductive holder and a second insulating layer, the second conductive holder partially covered with the second insulating layer, a portion of the second conductive holder exposed outside the second insulating layer forming a second contact portion and a second output portion;
wherein the first housing and the second housing are connected with each other to receive a battery therebetween, the first contact portion and the second contact portion are configured to be electrically connected with the battery, and the first output portion and the second output portion are configured to be electrically connected with an electronic module.

2. The battery case of claim 1, wherein the first conductive holder further includes a first recess, the first contact portion is disposed on a wall defining the first recess, the second conductive holder further includes a second recess, the second contact portion is disposed on a wall defining the second recess, the first recess and the second recess are communicated with each other and form a battery receiving room therebetween, and the battery receiving room is configured to receive the battery.

3. The battery case of claim 2, further including a conductive elastomer, wherein the conductive elastomer is received within the second recess, one side of the conductive elastomer is abutted against the second contact portion, and another side of the conductive elastomer is configured to be abutted against the battery.

4. The battery case of claim 1, further including a sealing member, wherein the first housing and the second housing restricts the sealing member therebetween.

5. The battery case of claim 1, wherein the first conductive holder has a first through hole disposed therethrough, the second conductive holder has a second through hole disposed therethrough, and the first through hole and the second through hole are coaxially arranged and configured for a shaft assembly of the bicycle pedal module to be disposed therethrough.

6. The battery case of claim 1, further including at least one fastening assembly, wherein the first conductive holder further includes at least one first assembling hole, the second conductive holder further includes at least one second assembling hole, a position of the at least one second assembling hole is matched with a position of the at least one first assembling hole, the at least one fastening assembly is disposed through the at least one first assembling hole and the at least one second assembling hole to connect the first housing with the second housing; the first insulating layer covers a wall defining the at least one first assembling hole, and the second insulating layer covers a wall defining the at least one second assembling hole.

7. The battery case of claim 3, further including a sealing member and at least one fastening assembly, wherein the first housing and the second housing restricts the sealing member therebetween, the first conductive holder further includes at least one first assembling hole, the second conductive holder further includes at least one second assembling hole, a position of the at least one second assembling hole is matched with a position of the at least one first assembling hole, the at least one fastening assembly is disposed through the at least one first assembling hole and the at least one second assembling hole to connect the first housing with the second housing; the first insulating layer covers a wall defining the at least one first assembling hole, and the second insulating layer covers a wall defining the at least one second assembling hole; the first conductive holder has a first through hole disposed therethrough, the second conductive holder has a second through hole disposed therethrough, and the first through hole and the second through hole are coaxially arranged and configured for a shaft assembly of the bicycle pedal module to be disposed therethrough; the first conductive holder is made of aluminum alloy, the second conductive holder is made of aluminum alloy; the sealing member includes a frame portion and a plate portion, the plate portion laterally extends within the frame portion, the plate portion has a third through hole disposed therethrough, the third through hole and the first through hole are coaxially arranged, a portion of the first housing and a portion of the second housing are disposed within the frame portion and restrict the plate portion therebetween, the plate portion further has an annular projection disposed thereon, the annular projection is abutted against and between the first housing and the second housing and configured to be disposed around the battery; in a manufacturing process of the first housing, the first conductive holder is subjected to an insulation process and the first conductive holder is completely covered with the first insulating layer, and portions of the first insulating layer are cut off to form the first contact portion and the first output portion, a manufacturing process of the second housing is the same as the manufacturing process of the first housing; the at least one fastening assembly includes a nut and a bolt, the nut is embedded within the at least one first assembling hole, the bolt is disposed through the second assembling hole and screwed to the nut; the battery is a button battery; the first housing is plate-shaped, the second housing is plate-shaped; the first housing and the second housing define an accommodating room therebetween, the accommodating room is configured to receive a conductive module electrically connected with the electronic module, the first output portion and the second output portion are respectively disposed on sidewalls of the first housing and the second housing defining the accommodating room, the first through hole and the second through hole respectively penetrate through the sidewalls, and the first output portion and the second output portion are respectively annularly disposed around an outside of the first through hole and an outside of the second through hole.

8. A bicycle pedal module, including:
a pedal body;
a shaft assembly, one side of the shaft assembly disposed within the pedal body, the other side of the shaft assembly configured to be connected with a crank;
a conductive module, positioned on a side of the shaft assembly remote from the pedal body, including a positive contact unit, a negative contact unit, a positive output end and a negative output end, the positive contact unit electrically connected with the positive output end, the negative contact unit electrically connected with the negative output end, the positive output end and the negative output end configured to be electrically connected with an electronic module; and
the battery case of claim 1, detachably disposed on the conductive module, the first output portion and the negative contact unit abutted against and electrically conducted with each other, the second output portion and the positive contact unit abutted against and electrically conducted with each other.

9. The bicycle pedal module of claim 8, wherein the battery case is rotatably disposed on the conductive module.

10. The bicycle pedal module of claim 8, wherein the conductive module further includes a printed circuit board (PCB) conductor, a pressing member and a sleeve member, the PCB conductor has the positive output end and the negative output end disposed thereon, the sleeve member includes a supporting portion and a tube portion, the supporting portion laterally protrudes from the tube portion, the PCB conductor is abutted against and between the pressing member and the supporting portion, the first housing and the second housing are assembled from an outer side of the pressing member and an outer side of the supporting portion respectively, the positive contact unit includes a plurality of positive pins, the negative contact unit includes a plurality of negative pins, the plurality of positive pins and the plurality of negative pins are connected with the PCB conductor and electrically conducted with the positive output end and the negative output end, one end of each of the plurality of positive pins is disposed through one of the pressing member and the supporting portion and abutted against the second output portion, one end of each of the plurality of negative pins is disposed through the other of the pressing member and the supporting portion and abutted against the first output portion, the sleeve member is sleeved to the shaft assembly, the tube portion and the shaft assembly define a chamber therebetween, the chamber is configured to receive the electronic module, and the positive output end and the negative output end protrude into the chamber.
